(19) United States
(12) Patent Application Publication
(10) Pub. No.: US 2005/0157485 A1
(43) Pub. Date: Jul. 21, 2005

(54) Decorative lighting device with windmill

(76) Inventor: Whiter Shieh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/759,030

(22) Filed: Jan. 20, 2004

(51) Int. Cl. F21V 21/00; F21V 33/00

(52) U.S. Cl. 362/96; 362/249; 362/234

(57) ABSTRACT

A decorative lighting device provided with a plurality of lighting elements and associated with a windmill is disclosed. The decorative lighting device includes a front panel showing a specific design and provided at a predetermined position with a window, a windmill mounted behind the front panel via a fixing frame to align with the window, extended lighting tubes provided along outer peripheries of the front panel and the window, and a plurality of light-emitting elements mounted on the front panel. A supporting pike is further connected to a lower rear part of the front panel for supporting and fixing the whole decorative lighting device with windmill to a desired location.

### BACKGROUND OF THE INVENTION

1. Field of the Invention

The present invention relates to a decorative lighting device, and more particularly to a decorative lighting device with windmill. Different types of lighting elements are mounted on a front panel, and a windmill is mounted behind the front panel and visible via a window on the front panel.

2. Description of the Prior Art

Christmas lighting decorations and similar products are usually hung on Christmas trees or trees in gardens. Such Christmas lighting decorations are rarely used with products showing specific designs. Taiwan Patent Publication No. 220080 discloses a two-piece ornament adapted to associate with Christmas lighting decorations. The ornament is transparent and includes a left and a right hollow half defining an inner space between them for receiving a Christmas light therein. Either the left or the right half of the ornament is internally provided with a pin for holding the Christmas light thereto. The left and the right half of the ornament are correspondingly provided at a joint thereof with a fastening pin and a retaining hole that are engaged with each other to close the two halves into a complete body enclosing the Christmas light therein. A notch is formed at the joint of the left and the right half for a power cord of the Christmas light to extend therethrough. The ornament may be differently shaped animals, plants or articles, and may include, for example, a candle, a ball, an apple, a deer, a bear, a pigeon, a Santa Claus, a Christmas tree, a bell, etc. The ornament may also be otherwise divided into an upper and a lower half, or a front and a rear half.

Currently, most of the conventional Christmas lighting decorations are in the form of light strings adapted for hanging on trees and buildings. Alternatively, individual Christmas lights are separately positioned in hollow ornaments and then hung on a certain article. These conventional Christmas lighting decorations are statically located at a fixed place but use flashing light strings to produce dynamically changeable views. Therefore, only a considerably monotonous decorating effect may be achieved. Moreover, the conventional Christmas lighting decorations could not be easily relocated.

It is therefore desirable to develop a decorative lighting device that has light and simple structure to allow easy relocation thereof, and is adapted to produce dynamical views to serve as a perfect lighting decoration.

### SUMMARY OF THE INVENTION

A primary object of the present invention is to provide a decorative lighting device with windmill, in which different lighting elements are associated with a windmill to create changeful and splendid views.

To achieve the above and other objects, the decorative lighting device with windmill of the present invention mainly includes a front panel showing a specific design and provided at a predetermined position with a window, a windmill mounted behind the front panel via a fixing frame to align with the window, extended lighting tubes provided along outer peripheries of the front panel and the window, and a plurality of light-emitting elements mounted on the front panel.

In a preferred embodiment of the present invention, a supporting pike is connected to a lower rear part of the front panel for supporting and fixing the whole decorative lighting device with windmill to a desired location, and the front panel may show different animals, flowers, landscapes, figures, etc. as a decoration. The windmill is fixed to a rear plate that has configuration and area corresponding to that of the window on the front panel and is located in alignment with the window, so that the windmill is visible via the window. The rear plate is fixed to the fixing frame and has decorative lighting tubes provided along an outer periphery thereof.

A user may choose a front panel having a personally preferred design. The lighting tubes provided along the outer periphery of the front panel highlights the specific design of the front panel, particularly when the decorative lighting device is mounted outdoors in a dim environment. The windmill is rotatable on the decorative lighting device to provide a dynamic decorating effect. Since the whole decorative lighting device with windmill of the present invention has light structure, it may be easily moved to any desired place for display or storage.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front perspective view of a decorative lighting device with windmill according to a first embodiment of the present invention;

FIG. 2 is a side view of the decorative lighting device of FIG. 1;

FIG. 3 is a front perspective view of a decorative lighting device with windmill according to a second embodiment of the present invention;

FIG. 4 is a side view the decorative lighting device of FIG. 3;

FIG. 5 is a front perspective view of a decorative lighting device with windmill according to a third embodiment of the present invention; and

FIG. 6 is a side view of the decorative lighting device of FIG. 5.

### DETAILED DESCRIPTION OF THE PREFERRED EMBODIMENTS

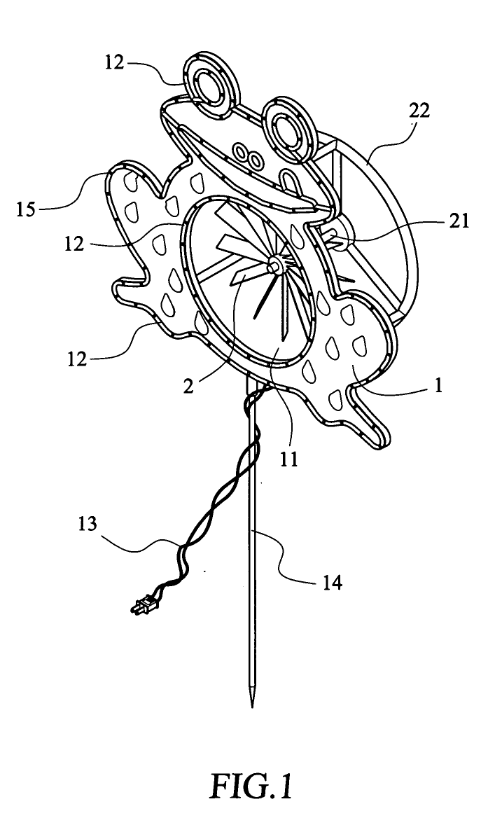

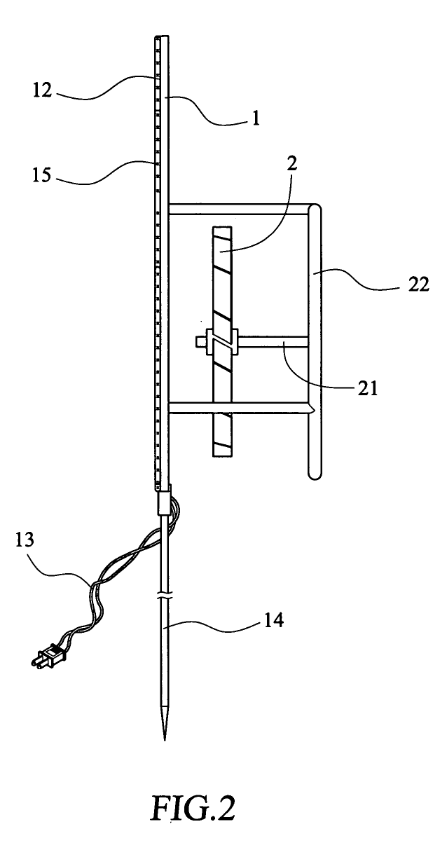

Please refer to FIGS. 1 and 2 that are a front perspective view and a side view respectively of a decorative lighting device with windmill according to a first embodiment of the present invention. As shown, in the first embodiment, the decorative lighting device includes a flat front panel 1 showing a specific design, such as a certain kind of animal, flower, landscape or figure, and having a window 11 provided at a predetermined position on the front panel 1.

Decorative lighting tubes 12, such as a commercially available meteoric lamp, may be separately provided along outer peripheries of the front panel 1 and the window 11. The decorative lighting tube 12 may be, for example, an extended tubular body having a plurality of light-emitting elements connected in serial or parallel, such as light-emitting diode (LED) lamps, provided therein to electrically connect to a power cord 13.

A supporting pike 14 is connected to a lower rear part of the front panel 1 for supporting and easily fixing the whole decorative lighting device outdoors, such as in a garden.

A windmill 2 is mounted behind the front panel 1 to generally align with the window 11. The windmill 2 has a centered axle 21, a rear end of which is fixed to a center of a fixing frame 22. With the fixing frame 22, the windmill 2 is stably located behind the window 11 with a suitable distance kept between it and the front panel 1.

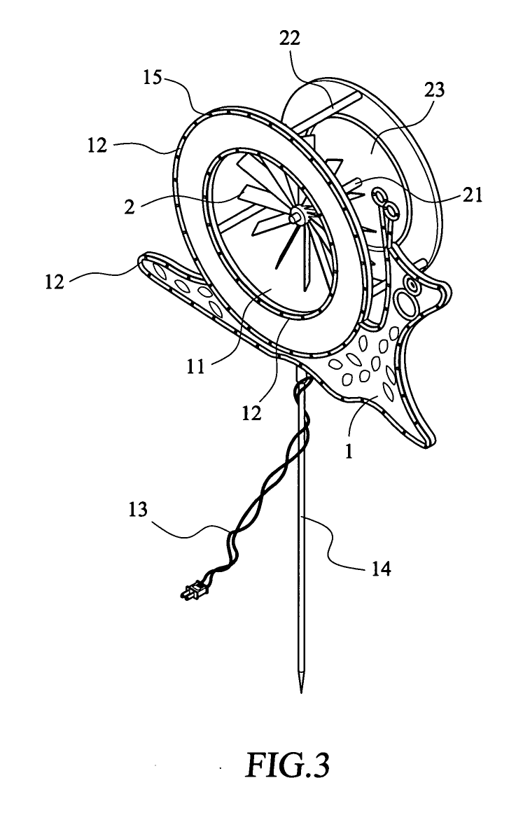

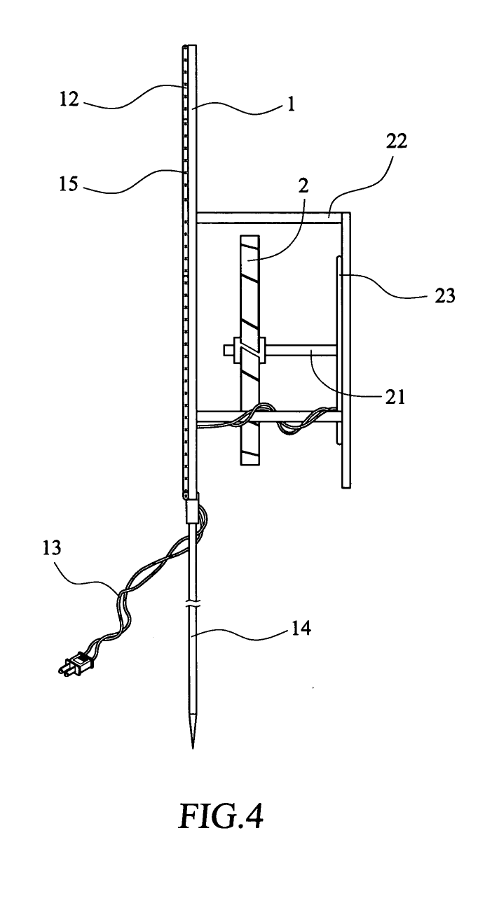

FIGS. 3 and 4 are front perspective and side views, respectively, of a decorative lighting device with windmill according to a second embodiment of the present invention. The second embodiment is substantially structurally similar to the first embodiment, and any component or member thereof similar or identical to that in the first embodiment will be denoted with the same reference numeral as in the first embodiment.

As shown, the front panel 1 in this second embodiment shows a different design, and a windmill 2 is mounted behind the front panel 1 to generally align with the window 11. The windmill 2 has a centered axle 21, a rear end of which is fixed to a center of a rear plate 23, which has a configuration and area corresponding to that of the window 11 on the front panel 1 and is in alignment with the window 11. The rear plate 23 is then fixed to the fixing frame 22 to locate the windmill 2 in place. Decorative lighting tubes 12 may also be provided along an outer periphery of the rear plate 23.

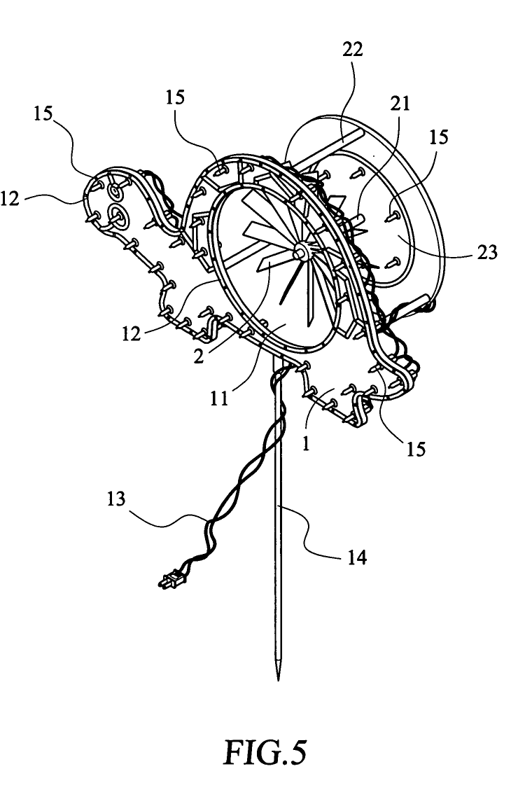

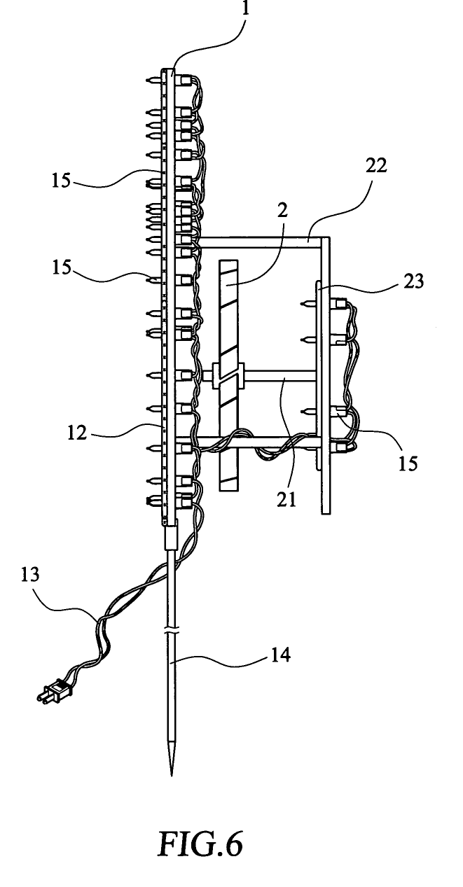

FIGS. 5 and 6 are front perspective and side views, respectively, of a decorative lighting device with windmill according to a third embodiment of the present invention. Again, any component or member of this third embodiment similar or identical to that in the first and the second embodiment will be denoted with the same reference numeral. As shown, the front panel 1 in the third embodiment shows a different design. In addition to the decorative light tubes 12 provided along the outer periphery of the front panel 1, there are also a plurality of light-emitting elements 15 mounted in through holes preformed on the front panel 1, making the front panel 1 looked more splendid. The rear plate 23 may also be provided at a front side with the light-emitting elements 15 to create changeful visions for the decorative lighting device with windmill.

The present invention has been described with some preferred embodiments thereof and it is understood that many changes and modifications in the described embodiments can be carried out without departing from the scope and the spirit of the invention that is intended to be limited only by the appended claims.

1. A decorative lighting device, comprising:
a front panel having a specific design and provided at a predetermined position with a window;
a windmill mounted behind said front panel to align with said window; and
a plurality of light-emitting elements mounted on said front panel to produce light.

2. The decorative lighting device as claimed in claim 1, further comprising a supporting pike connected to a lower rear part of said front panel for supporting and fixing said decorative lighting device.

3. The decorative lighting device as claimed in claim 1, further comprising a rear plate, said rear plate being located in alignment with said window on said front panel.

4. The decorative lighting device as claimed in claim 3, wherein said windmill is fixed to a front side of said rear plate at a position corresponding to said window on said front panel.
